(19) United States
(12) Patent Application Publication
(10) Pub. No.: US 2021/0214208 A1
(43) Pub. Date: Jul. 15, 2021

(54) BEVERAGE VENDING MACHINE

(71) Applicant: Wenmao LIN, Shantou (CN)

(72) Inventor: Wenmao LIN, Shantou (CN)

(21) Appl. No.: 17/268,284

(22) PCT Filed: Feb. 27, 2019
(86) PCT No.: PCT/CN2019/076378

§ 371 Date: Feb. 12, 2021

(30) Foreign Application Priority Data
Aug. 18, 2018 (CN) CN201810986963.1

(51) Int. Cl. B67D 1/08

(52) U.S. Cl. CPC B67D 1/0801

(57) ABSTRACT

A beverage vending machine includes a machine body, and a vending mechanism and a beverage storage device which are mounted on the machine body. The vending mechanism is connected with the beverage storage device. The beverage storage device includes an inner bag and an external packing container; the inner bag is mounted inside the external packing container; the inner bag has a beverage inlet/outlet pipe; the beverage inlet/outlet pipe is mounted on the inner bag, and an opening of the beverage inlet/outlet pipe passes through the external packing container and extends out; and the external packing container is provided with a gas inlet/outlet pipe communicating with an external gas source. The present disclosure the volume of the gas in the external packing container is increased to squeeze the inner bag to deliver the beverage that has the same volume as the gas.

### TECHNICAL FIELD

The present disclosure relates to beverage vending equipment, and more specifically relates to a beverage vending machine.

### BACKGROUND

Beverages usually include alcoholic beverages (such as beer) and non-alcoholic beverages (such as cola). There is usually beverage vending equipment for selling these beverages in places such as bars and restaurants. At the present, the beverage vending equipment usually includes a machine body, and a vending mechanism and a beverage storage device which are mounted on the machine body, and the vending mechanism is connected to the beverage storage device. The beverage storage device usually uses barrels or cans to store beverages. When a certain volume of beverage is needed, a certain volume of gas is input into a barrel or can to squeeze out the beverage.

For example, a bulk bear vending machine disclosed by the Chinese patent document No. CN207294156U structurally includes a bear barrel, a bear extractor, and a bear spear, and consists of an isolation plate, carbon dioxide gas input equipment, a carbon dioxide output valve, and a carbon dioxide pressure regulator. The isolation plate is welded inside the bear barrel. The isolation plate divides the interior of the bear barrel into two independent spaces: an upper one and a lower one. A bear spear body is installed in the middle of the bear barrel. The carbon dioxide output valve is installed at the left upper part of the bear barrel. There is a guide slot in the left inner part of a housing of the bear extractor; the carbon dioxide gas input equipment is provided with a gas inlet pipe and a gas exhaust pipe. The carbon dioxide gas input equipment is located at the right inner part of the housing of the bear extractor. The carbon dioxide pressure regulator and the carbon dioxide gas input equipment are connected through two rubber hoses.

However, this beverage vending equipment has two disadvantages:

1. Since gas is used and put into the bear barrel to extrude the beverage, the beverage is in contact with the gas, and the quality of the beverage is easy to affect, and the barrel is difficult to clean after the beverage is emptied. Furthermore, since a container is in direct contact with the beverage, it is necessary to use a material that can be used to store beverages, leading to high cost, and the container cannot be abandoned but only recycled for reuse.

2. Since the bear barrel is large in volume and cannot be changed, its material is usually wood or metal, which is very heavy, difficult to transport and recycle, and extremely high in use cost.

### SUMMARY

The technical problem to be solved by the present disclosure is to provide a beverage vending machine. Such a beverage vending machine can effectively avoid contact between a beverage and gas and also avoid direct contact between an external packing container and the beverage. Technical solution of the present disclosure is as follows:

A beverage vending machine includes a machine body, and a vending mechanism and a beverage storage device which are mounted on the machine body. The vending mechanism is connected with the beverage storage device. The beverage storage device includes an inner bag and an external packing container; the inner bag is mounted inside the external packing container; the inner bag has a beverage inlet/outlet pipe; the beverage inlet/outlet pipe is mounted on the inner bag, and an opening of the beverage inlet/outlet pipe passes through the external packing container and extends out; and the external packing container is provided with a gas inlet/outlet pipe communicating with an external gas source. The inner bag is used to store a beverage, and the external packing container is used for inflating and squeezing the inner bag to deliver the beverage, so that the inner bag just needs to be cleaned after the beverage is emptied, and the cleaning is relatively convenient. Furthermore, the external packing container may be made of other ordinary materials since it is not in direct contact with the beverage, and the production cost is greatly reduced.

Preferably, the inner bag is a first plastic bag.

More preferably, a material of the first plastic bag is food-grade plastic.

More preferably, the food-grade plastic is polyethylene, poly-octylene, polybutylene, or is copolymerized by polyethylene, poly-octylene, and polybutylene.

More preferably, the inner bag is detachably mounted inside the external packing container. Such a design makes the inner bag cleaned more conveniently and quickly.

In one solution, the external packing container is a plastic barrel or a metal barrel. The plastic barrel may select various plastic barrels made of plastic, and the metal barrel may select various barrels made of metal, such as an aluminum barrel, a copper barrel and an alloy barrel. In this solution, it is not necessary to use a satisfactory particular material, so that the container is low in cost and relatively light in weight, and can be recycled for beverage storage or other [symbol] solution, the external packing container is a second plastic bag. This solution can greatly reduce the volume of a double-layer beverage storage soft packing container after the beverage is emptied, so that the container is light in weight, and easy to recycle for beverage storage or other purposes.

Preferably, the vending mechanism includes a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe. The control device controls the inflation device to inflate the packing container with a certain volume of gas to squeeze the inner bag and cause the inner bag deliver, by means of the beverage filling head, the same volume of beverage, thereby filling of the beverage.

Compared with the prior art, the present disclosure has the beneficial effects that the beverage storage device is provided with the inner bag and the external packing container, and the volume of the gas in the external packing container is increased to squeeze the inner bag to deliver the beverage that has the same volume as the gas, which changes a beverage extrusion method, so that the gas can be effectively avoided from affecting the quality of the beverage, and the inner bag is cleaned more conveniently and quickly; since the external packing container is not in direct contact with the beverage, an ordinary material can be used, which greatly reduces the production cost; the inner bag is designed to be detachable, so it is convenient to clean and replace, the production efficiency can be greatly improved, and the production cost can be reduced; and when the external packing container is designed to be a plastic bag, the volume of the double-layer beverage storage soft packing container can be greatly reduced after the beverage is emptied, and the container is light in weight and easy to recycle.

### BRIEF DESCRIPTION OF THE DRAWINGS

FIG. 1 is a sectional schematic diagram of Embodiment 1 of the present disclosure; and

FIG. 2 is a sectional diagram of a beverage storage device of Embodiment 1 shown in FIG. 1.

### DESCRIPTION OF THE EMBODIMENTS

### Embodiment 1

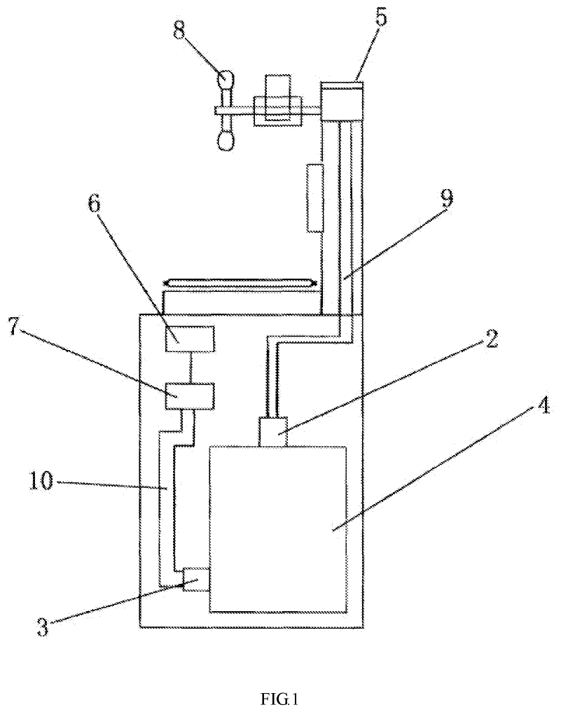

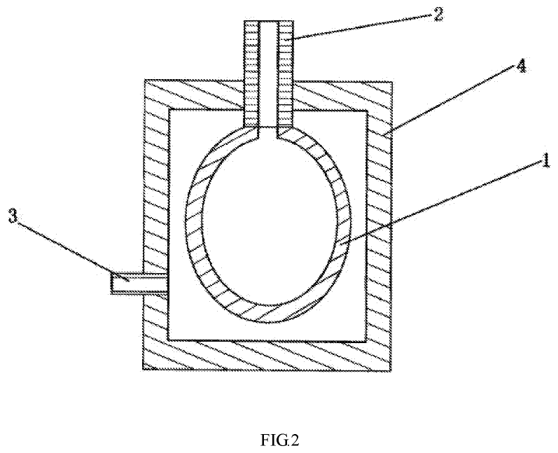

As shown in FIGS. 1 and 2, a beverage vending machine in the present embodiment 1 includes a machine body 5, and a vending mechanism and a beverage storage device which are mounted on the machine body 5, and the vending mechanism is connected to the beverage storage device.

The beverage storage device includes an inner bag 1 and an external packing container; the inner bag 1 is mounted inside the external packing container; the inner bag 1 has a beverage inlet/outlet pipe 2; the beverage inlet/outlet pipe 2 is mounted on the inner bag 1, and an opening of the beverage inlet/outlet pipe 2 passes through the external packing container and extends out; and the external packing container is provided with a gas inlet/outlet pipe 3 communicating with an external gas source. The inner bag 1 is used to store a beverage, and the external packing container is used for inflating and squeezing the inner bag 1 to deliver the beverage, so that the inner bag 1 just needs to be cleaned after the beverage is emptied, and the cleaning is relatively convenient. Furthermore, the external packing container may be made of other ordinary materials since it is not in direct contact with the beverage, and the production cost is greatly reduced.

The inner bag 1 is a first plastic bag.

A material of the first plastic bag is food-grade plastic.

The food-grade plastic selects polyethylene.

The external packing container is a plastic barrel 4. In this solution, it is not necessary to use a satisfactory particular material, so that the container is low in cost and relatively light in weight, and can be recycled for beverage storage or other purposes.

The vending mechanism includes a control device 6, an inflation device 7 and a beverage filling head 8; the control device 6, the inflation device 7 and the beverage filling head 8 are respectively mounted on the machine body; the control device 6 is electrically connected with the inflation device 7; the beverage filling head 8 communicates with the beverage inlet/outlet pipe 2 by means of a beverage output pipe 9; and the inflation device 7 communicates with the gas inlet/outlet pipe 3 by means of a gas pipe 10. The control device 6 controls the inflation device 7 to inflate the external packing container with a certain volume of gas to squeeze the inner bag 1 and cause the inner bag 1 to deliver, by means of the beverage filling head 8, the same volume of beverage, thereby completing filling of the beverage.

### Embodiment 2

The beverage vending machine in the present embodiment differs from Embodiment 1 in that:

The food-grade plastic is poly-octylene.

The inner bag 1 is detachably mounted inside the external packing container. Such a design makes the inner bag 1 cleaned more conveniently and quickly.

The external packing container is a second plastic bag. This solution can greatly reduce the volume of a double-layer beverage storage soft packing container after the beverage is emptied, so that the container is light in weight, and easy to recycle for beverage storage or other purposes.

### Embodiment 3

The beverage vending machine in the present embodiment differs from Embodiment 1 in that:

The food-grade plastic is polybutylene.

The inner bag 1 is detachably mounted inside the external packing container. Such a design makes the inner bag 1 cleaned more conveniently and quickly.

The external packing container is an aluminum barrel. In this solution, it is not necessary to use a satisfactory particular material, so that the container is low in cost and relatively light in weight, and can be recycled for beverage storage or other purposes.

### Embodiment 4

The beverage vending machine in the present embodiment differs from Embodiment 1 in that:

The food-grade plastic is copolymerized by polyethylene, poly-octylene, and polybutylene.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A beverage vending machine, comprising a machine body, and a vending mechanism and a beverage storage device which are mounted on the machine body, wherein the vending mechanism is connected with the beverage storage device; the beverage storage device comprises an inner bag and an external packing container; the inner bag is mounted inside the external packing container; the inner bag has a beverage inlet/outlet pipe; the beverage inlet/outlet pipe is mounted on the inner bag, and an opening of the beverage inlet/outlet pipe passes through the external packing container and extends out; and the external packing container is provided with a gas inlet/outlet pipe communicating with an external gas source.

2. The beverage vending machine according to claim 1, wherein the inner bag is a first plastic bag.

3. The beverage vending machine according to claim 2, wherein a material of the first plastic bag is food-grade plastic.

4. The beverage vending machine according to claim 3, wherein the food-grade plastic is polyethylene, poly-octylene, polybutylene, or is copolymerized by polyethylene, poly-octylene, and polybutylene.

5. The beverage vending machine according to claim 1, wherein the inner bag is detachably mounted inside the external packing container.

6. The beverage vending machine according to claim 1, wherein the external packing container is a plastic barrel or a metal barrel.

7. The beverage vending machine according to claim 1, wherein the external packing container is a second plastic bag.

8. The beverage vending machine according to claim 1, wherein the vending mechanism comprises a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe.

9. The beverage vending machine according to claim 2, wherein the external packing container is a plastic barrel or a metal barrel.

10. The beverage vending machine according to claim 3, wherein the external packing container is a plastic barrel or a metal barrel.

11. The beverage vending machine according to claim 4, wherein the external packing container is a plastic barrel or a metal barrel.

12. The beverage vending machine according to claim 5, wherein the external packing container is a plastic barrel or a metal barrel.

13. The beverage vending machine according to claim 2, wherein the external packing container is a second plastic bag.

14. The beverage vending machine according to claim 3, wherein the external packing container is a second plastic bag.

15. The beverage vending machine according to claim 4, wherein the external packing container is a second plastic bag.

16. The beverage vending machine according to claim 5, wherein the external packing container is a second plastic bag.

17. The beverage vending machine according to claim 2, wherein the vending mechanism comprises a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe.

18. The beverage vending machine according to claim 3, wherein the vending mechanism comprises a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe.

19. The beverage vending machine according to claim 4, wherein the vending mechanism comprises a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe.

20. The beverage vending machine according to claim 5, wherein the vending mechanism comprises a control device, an inflation device and a beverage filling head; the control device, the inflation device and the beverage filling head are respectively mounted on the machine body; the control device is electrically connected with the inflation device; the beverage filling head communicates with the beverage inlet/outlet pipe by means of a beverage output pipe; and the inflation device communicates with the gas inlet/outlet pipe by means of a gas pipe.
